(19) United States
(12) Patent Application Publication
(10) Pub. No.: US 2015/0093036 A1
(43) Pub. Date: Apr. 2, 2015

(54) VIDEO/IMAGE DATA PROCESSING SYSTEM AND METHOD OF PROCESSING VIDEO/IMAGE DATA

(71) Applicants: Yong-Ha Park, Seongnam-si (KR); Jin-Aeon Lee, Suwon-si (KR)

(72) Inventors: Yong-Ha Park, Seongnam-si (KR); Jin-Aeon Lee, Suwon-si (KR)

(21) Appl. No.: 14/501,768

(22) Filed: Sep. 30, 2014

(30) Foreign Application Priority Data
Oct. 2, 2013 (KR) 10-2013-0117982

(51) Int. Cl. H04N 19/44; H04N 19/42

(52) U.S. Cl. CPC H04N 19/44; H04N 19/439
USPC 382/233

(57) ABSTRACT

A system-on-a-chip (SOC) that is able to randomly access target data of a video/image includes a JPEG decoder, a graphic processing unit (GPU) and a central processing unit (CPU). The JPEG decoder receives an input stream having a sequentially accessible first compression format, decodes the input stream to generate first data, and encodes the first data to generate an output stream having a randomly accessible second compression format. The GPU receives the output stream and performs graphic processing on the output stream. Therefore, the SOC readily performs graphic processing by repeatedly receiving video/image data in a short time from a storage unit in which the data is stored using a randomly accessible compression format.

### CROSS-REFERENCE TO RELATED APPLICATION

This application claims priority under 35 U.S.C. §119 to Korean Patent Application No. 10-2013-0117982 filed on Oct. 2, 2013, the disclosure of which is hereby incorporated by reference in its entirety.

### BACKGROUND

1. Field

Embodiments of the inventive concepts relate to a video/image data processing system and to methods of processing video image data, and more particularly, to video/image data processing systems and methods of processing video image data capable of converting a compression format so that the video/image data can be used for graphic processing.

2. Description of Related Art

Video/image data may be compressed and stored in order conserve system memory resources. In particular, blocks of compressed video/image data stream can be sequentially decoded beginning with a starting block and continuing to a data block including target data. As such, the compressed video/image data should be sequentially accessed. Such sequential access places certain limitations in the manner video/image data, compressed using a conventional compression method, can be used in graphic processing.

### SUMMARY

Embodiments of the inventive concepts provide a video/image data processing system well suited for use in graphic processing.

Embodiments of the inventive concepts also provide a system-on-a-chip (SOC) including the video/image data processing system.

Embodiments of the inventive concepts also provide a method of processing video/image data capable of being used in graphic processing.

The technical objectives of the inventive concepts are not limited to the above disclosure, and other objectives may become apparent to those of ordinary skill in the art based on the following descriptions.

In an aspect, a system-on-a-chip (SOC), comprises: a JPEG decoder configured to receive an input stream of data blocks having a first compression format with which a sequential access is possible, to decode the input stream of data blocks to generate first data, and to encode the first data to generate an output stream of data blocks having a second compression format with which a random access is possible; a graphic processing unit (GPU) configured to perform graphic processing on the output stream; and a central processing unit (CPU) configured to control operations of the JPEG decoder and the GPU.

In some embodiments, the GPU is configured to jump directly to a target block that includes target data among a plurality of blocks of the output stream of data blocks and to decode the target block.

In some embodiments, the SOC further comprises: a buffer circuit configured to store the first data that is the decoded data of the input stream of data blocks.

In another aspect, a video/image data processing system including a transcoding circuit comprises: a first circuit configured to receive an input stream of data blocks having a first compression format with which a sequential access is possible, and to decode the input stream of data blocks to generate first data, and a second circuit configured to encode the first data to generate an output stream of data blocks having a second compression format with which a random access is possible.

In some embodiments, the first compression format and the second compression format are configured to be block-based coded formats.

In some embodiments, the transcoding circuit comprises: a decoder configured to decode the input stream of data blocks to generate the first data; and an encoder configured to encode the first data to generate the output stream of data blocks having the second compression format with which random access is possible.

In some embodiments, the transcoding circuit comprises: a decoder configured to decode the input stream of data blocks to generate the first data; a buffer circuit configured to store the first data that is the decoded data of the input stream of data blocks; and an encoder configured to encode the first data to generate the output stream of data blocks having the second compression format with which random access is possible.

In some embodiments, the input stream and the output stream include a plurality of data blocks respectively.

In some embodiments, the transcoding circuit is configured to sequentially decode the input stream of data blocks from a beginning block to a block that includes target data among the plurality of blocks of the input stream.

In some embodiments, the system further comprises: a GPU configured to receive the output stream of data blocks, and to decode the output stream of data blocks to perform graphic processing.

In some embodiments, the GPU is configured to jump to a target block that includes target data among a plurality of blocks of the output stream and to decode the first block.

In some embodiments, a data size of a decoded result of the output stream of data blocks having the second compression format is smaller than the data size of a decoded result of the input stream of data blocks having the first compression format.

In some embodiments, a buffer size needed to store a decoded result of the output stream of data blocks having the second compression format is smaller than the buffer size needed to store a decoded result of the input stream of data blocks having the first compression format.

In another aspect, a video/image data processing system, comprising: a first storage unit; a transcoding circuit configured to receive an input stream of data blocks having a first compression format with which a sequential access is possible from the first storage unit, to decode the input stream of data blocks to generate first data, and to encode the first data to generate an output stream of data blocks having a second compression format with which a random access is possible; and a second storage unit configured to receive and store the output stream of data blocks from the transcoding circuit.

In another aspect, a method of processing video/image data for using the video/image data in a graphic process comprises: receiving an input stream having a plurality of data blocks and a first compression format with which a sequential access is possible; decoding the input stream to generate first data, and encoding the first data to generate an output stream of data blocks having a plurality of blocks and a second compression format with which a random access is possible.

In some embodiments, the method further comprises: storing the first data in a buffer circuit.

In some embodiments, the first compression format and the second compression format are block-based coded formats.

In some embodiments, the generating of the first data comprises: sequentially decoding the plurality of blocks of the input stream from a beginning block to a block having target data.

In some embodiments, the method further comprises: storing the output stream of data blocks in a storage unit.

In some embodiments, the method further comprises receiving the output stream from the storage unit; and decoding the output stream of data blocks to use in the graphic process.

In some embodiments, the decoding of the output stream is configured to jump to a target block that includes target data among a plurality of blocks of the output stream, and to decode the target block.

In some embodiments, the decoding of the output stream is configured to include reading a header of the output stream of data blocks, jumping to a target block indicated by the header among a plurality of blocks of the output stream, and decoding the target block.

In some embodiments, the target block is configured to include target data.

In some embodiments, the second compression format is configured to be used for a texture mapping in a three dimensional (3-D) graphic process.

In some embodiments, the first compression format is an image/video compression format selected from MEG PNG, GIF, MPEG, H.264 and HEVC, and the second compression format is a texture compression format selected from ASTC, S3TC, ETC, PVRTC, BC1, BC2, BC3, BC4, BC5, BC6 and BC7.

In another aspect, a video/image data processing system comprises: a transcoder including: a decoder configured to receive an input stream of data blocks having a first data compression format having a sequential access arrangement, and to decode the input stream of data blocks to generate first data; and an encoder configured to encode the first data to generate an output stream of data blocks having a second data compression format having a random access arrangement, the output stream of data blocks arranged in an order, the order including a first block which is a first block in the order and a target block including target data which is a block in the order other than the first block; and a graphics processing unit that decodes the target block of the output stream of data blocks in advance of the first block.

In some embodiments, a data size of a decoded result of the output stream of data blocks having the second compression format is smaller than the data size of a decoded result of the input stream of data blocks having the first compression format.

In some embodiments, the output stream of data blocks includes a header and wherein the graphics processing unit processes the header to determine the location of the target block.

In some embodiments, the video/image data processing system further comprises a buffer circuit that stores the first data prior to encoding the first data by the encoder.

In some embodiments, the first compression format is an image/video compression format selected from JPEG, PNG, GIF, MPEG, H.264 and HEVC, and the second compression format is a texture compression format selected from ASTC, S3TC, ETC, PVRTC, BC1, BC2, BC3, BC4, BC5, BC6 and BC7.

In this manner, in accordance with inventive concepts, the video/image data processing system according to embodiments of the inventive concepts can be configured to decode an entire stream of the video/image data, and store the video/image data in a randomly accessible compression format in a storage unit. Therefore, the video/image data processing system can readily perform graphic processing by repeatedly and rapidly receiving video/image data from a storage unit in which the data is stored using a randomly accessible compression format when the graphic processing unit (GPU) performs graphic processing.

### BRIEF DESCRIPTION OF THE DRAWINGS

The foregoing and other features and advantages of the inventive concepts will be apparent from the more particular description of embodiments of the inventive concepts, as illustrated in the accompanying drawings in which like reference characters refer to the same parts throughout the different views. The drawings are not necessarily to scale, emphasis instead being placed upon illustrating the principles of the inventive concepts. In the drawings:

FIG. 1 is a block diagram illustrating a video/image data processing system, in accordance with an embodiment of the inventive concepts;

FIG. 2 is a block diagram illustrating an embodiment of the transcoding circuit included in the video/image data processing system of FIG. 1;

FIG. 3 is a block diagram illustrating another embodiment of a transcoding circuit included in the video/image data processing system of FIG. 1;

FIG. 4 and FIG. 5 are diagrams illustrating embodiments of decoding sequences of an input stream and an output stream of the transcoding circuit of FIG. 2;

FIG. 6 is a block diagram illustrating a video/image data processing system, in accordance with another embodiment of the inventive concepts;

FIG. 7 is a block diagram illustrating a video/image data processing system, in accordance with another embodiment of the inventive concepts;

FIG. 8 is a block diagram illustrating a video/image data processing system, in accordance with another embodiment of the inventive concepts;

FIG. 9 is a block diagram illustrating a system-on-a-chip (SOC) that includes one of the video/image data processing systems shown in FIGS. 1, 6, 7 and 8;

FIG. 10 is a flow chart illustrating a method of processing video/image data, in accordance with an embodiment of the inventive concepts;

FIG. 11 is a flow chart illustrating a method of processing video/image data, in accordance with another embodiment of the inventive concepts;

FIG. 12 is a flow chart illustrating a method of processing video/image data, in accordance with still another embodiment of the inventive concepts;

FIG. 13 is a flow chart illustrating a method of processing video/image data, in accordance with yet another embodiment of the inventive concepts;

FIG. 14 is a block diagram illustrating an example of a computer system that includes one of the video/image data processing systems shown in FIGS. 1, 6, 7 and 8;

FIG. 15 is a block diagram illustrating another example of a computer system that includes one of the video/image data processing systems shown in FIGS. 1, 6, 7 and 8; and

FIG. 16 is a block diagram illustrating still another example of a computer system that includes one of the video/image data processing systems shown in FIGS. 1, 6, 7 and 8.

### DETAILED DESCRIPTION OF EMBODIMENTS

Various embodiments will now be described more fully with reference to the accompanying drawings in which some embodiments are shown. These inventive concepts may, however, be embodied in different forms and should not be construed as limited to the embodiments set forth herein. Rather, these embodiments are provided so that this disclosure is thorough and complete and fully conveys the inventive concepts to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present inventive concept.

Spatially relative terms, such as “beneath,” “below,” “lower,” “above,” “upper” and the like, may be used herein for ease of description to describe one element's or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the present inventive concept. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

For purposes of the present disclosure, the term “memory device” includes various types of memories, including memory units, devices and systems, including both discrete and integrated.

FIG. 1 is a block diagram illustrating a video/image data processing system 100, in accordance with an embodiment of the inventive concepts.

Referring to FIG. 1, the video/image data processing system 100 may include a transcoding circuit 110 and a storage unit 120. The transcoding circuit 110 receives an input stream STREAM_IN having a first compression format with which a sequential access is possible from the storage unit 120, decodes the input stream STREAM_IN to generate first data, encodes the first data to generate an output stream STREAM_OUT having a second compression format with which a random access is possible, and stores the output stream STREAM_OUT in the storage unit 120. In some embodiments, the storage unit 120 may comprise a memory unit that is of the video/image data processing system 100, or a memory device or system that is external to the video/image data processing system 100. When the storage unit 120 takes the form of a memory device that is external to the video/image data processing system 100, the transcoding circuit 110 may receive/transmit data from/to the storage unit 120 through the operation of a memory controller (not shown) and a compatible system bus (not shown).

In some embodiments, the video/image data processing system 100 of FIG. 1 may further include a buffer circuit (not shown) for storing the first data that is the decoded data of the input stream STREAM_IN. In some embodiments, the buffer circuit may be included in the transcoding circuit 110.

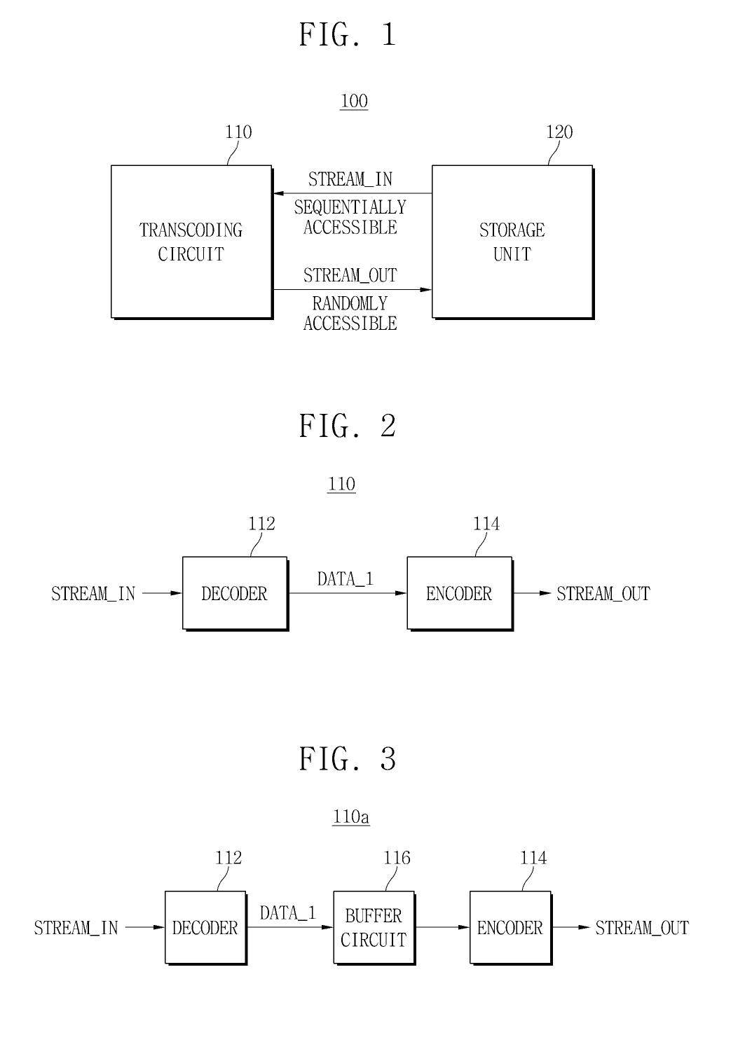

FIG. 2 is a circuit diagram illustrating an embodiment of the transcoding circuit 110 included in the video/image data processing system of FIG. 1.

Referring to FIG. 2, the transcoding circuit 110 may include a decoder 112 and an encoder 114. The decoder 112 operates to decode the input stream STREAM_IN to generate the first data DATA_{—}1, and the encoder 114 operates to encode the first data DATA_{—}1 to generate an output stream STREAM_OUT having a second compression format with which a random access is possible.

FIG. 3 is a block diagram illustrating another embodiment of a transcoding circuit 110a included in the video/image data processing system of FIG. 1.

Referring to FIG. 3, the transcoding circuit 110a may include a decoder 112, a buffer circuit 116 and an encoder 114. The decoder 112 operates to decode the input stream STREAM_IN to generate the first data DATA_{—}1. The buffer circuit 116 stores the first data DATA_{—}1 that is the decoded data of the input stream STREAM_IN. The encoder 114 receives the first data DATA_{—}1 from the buffer circuit 116, and encodes the first data DATA_{—}1 to generate an output stream STREAM_OUT having a second compression format with which a random access is possible.

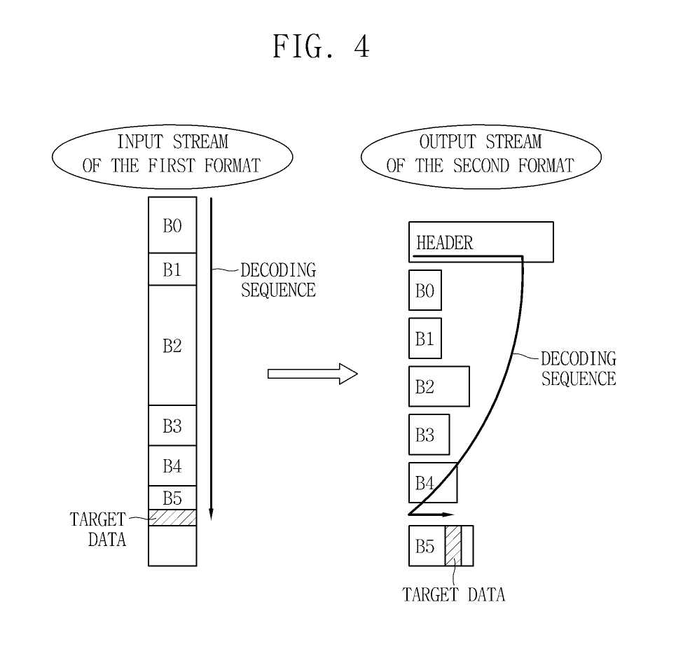

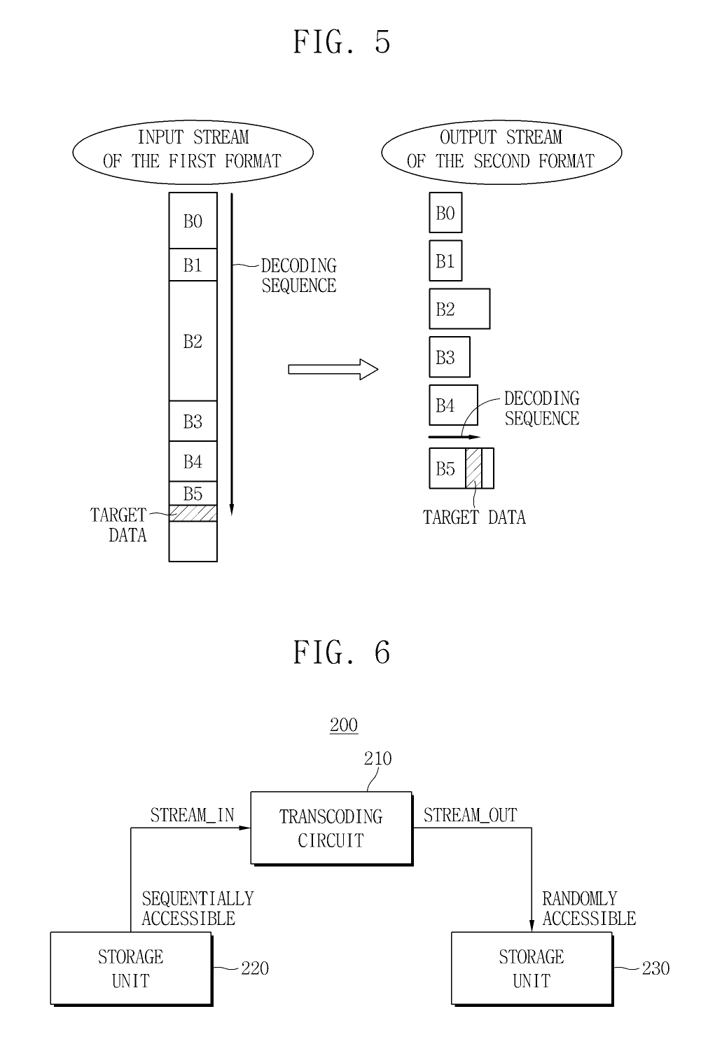

FIG. 4 and FIG. 5 are diagrams illustrating embodiments of decoding sequences of an input stream and an output stream of the transcoding circuit of FIG. 2. The decoding sequence when the output stream has a header is shown in FIG. 4, and the decoding sequence when the output stream does not have the header is shown in FIG. 5.

Referring to FIG. 4, the input stream STREAM_IN and the output stream STREAM_OUT may include a plurality of data blocks B0 . . . B5 respectively. Though the structure in which the input stream STREAM_IN and the output stream STREAM_OUT include six data blocks B0 to B5 respectively in the illustration of the embodiment of FIG. 4, the input stream STREAM_IN and the output stream STREAM_OUT may include an arbitrary number of blocks respectively, that is less than six or greater than six. The transcoding circuit may sequentially decode the input stream from an initial block B0 to a target block B5 that includes target data among the plurality of blocks B0 to B5 of the input stream. In some embodiments, a graphic processing unit (GPU) may be configured to read the header HEADER of the output stream STREAM_OUT, jump directly to a target block B5 indicated by the header HEADER among the plurality of blocks B0 to B5 of the output stream STREAM_OUT, and decode the target block B5 for graphic processing.

Referring to FIG. 5, in a case where output stream of the second format does not include a header, the GPU may jump directly to a target block B5 that includes target data among the plurality of blocks B0 to B5 of the output stream STREAM_OUT, and decode the first block B5 for graphic processing.

FIG. 6 is a block diagram illustrating a video/image data processing system 200 in accordance with another embodiment of the inventive concepts.

Referring to FIG. 6, in some embodiments, the video/image data processing system 200 may include a first storage unit 220, a transcoding circuit 210 and a second storage unit 230. In some embodiments, the transcoding circuit 210 may receive an input stream STREAM_IN having a first compression format with which a sequential access is possible from the first storage unit 220, decode the input stream STREAM_IN to generate first data, and encode the first data to generate an output stream STREAM_OUT having a second compression format with which a random access is possible. The second storage unit 230 receives and stores the output stream STREAM_OUT from the transcoding circuit 210.

In some embodiments, the first storage unit 220 and the second storage unit 230 may comprise memory units, devices or systems that are within the video/image data processing system 200, or may comprise memory units, devices or systems that are external to the video/image data processing system 200. In a case where the first storage unit 220 and the second storage unit 230 comprise memory devices that are external to the video/image data processing system 200, the transcoding circuit 210 may receive/transmit data from/to the storage units 220 and 230 through the operation of a memory controller (not shown) and a compatible system bus (not shown).

In FIG. 6, in some embodiments, the first compression format and the second compression format may be block-based coded formats.

The video/image data processing system 200 of FIG. 6 may further include a buffer circuit (not shown) for storing the first data that is the decoded data of the input stream STREAM_IN. In some embodiments, the buffer circuit may be included in the transcoding circuit 210.

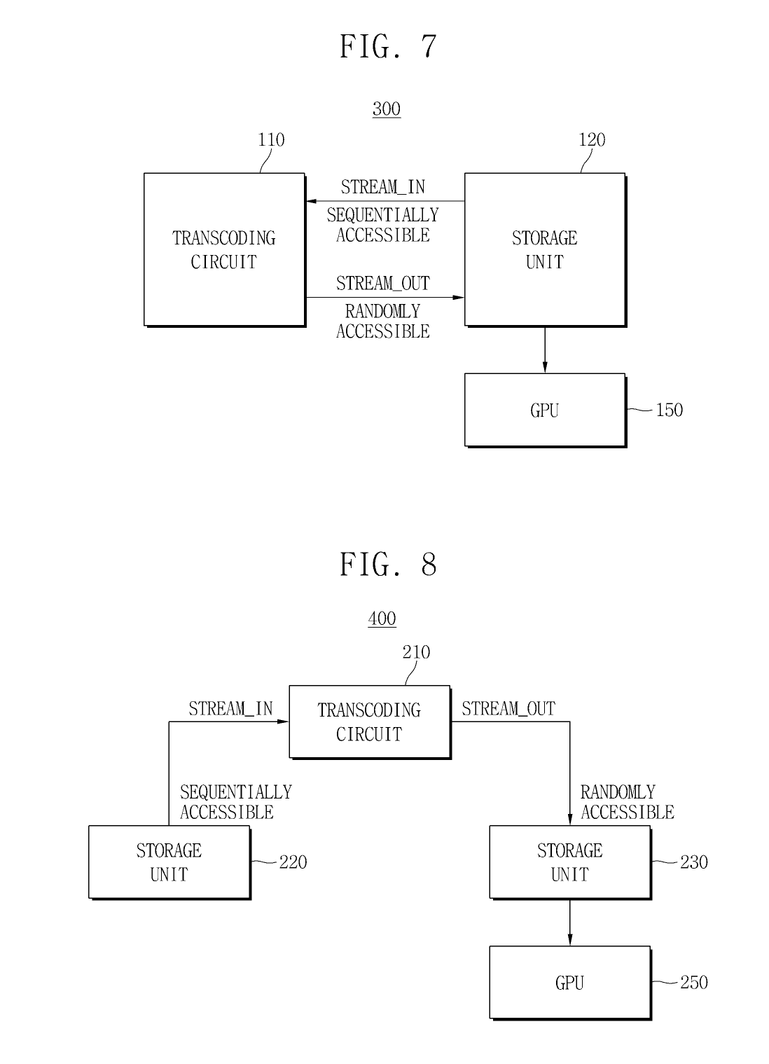

FIG. 7 is a block diagram illustrating a video/image data processing system 300 in accordance with another embodiment of the inventive concepts.

Referring to the embodiment of FIG. 7, the video/image data processing system 300 may include a transcoding circuit 110, a storage unit 120 and a GPU150.

The transcoding circuit 110 receives an input stream STREAM_IN having a first compression format with which a sequential access is possible from the storage unit 120, decodes the input stream STREAM_IN to generate first data, encodes the first data to generate an output stream STREAM_OUT having a second compression format with which a random access is possible, and stores the output stream STREAM_OUT in the storage unit 120. The storage unit 120 may comprise a memory unit, device, or system within the video/image data processing system 300, or a memory unit, device, or system that is external to the video/image data processing system 300. In a case where the storage unit 120 comprises a memory device that is external to the video/image data processing system 300, the transcoding circuit 110 may receive/transmit data from/to the storage unit 120 through a memory controller (not drawn) and a system bus (not drawn). The GPU 150 receives the output stream STREAM_OUT from the storage unit 120, and performs graphic processing on the output stream STREAM_OUT. When the storage unit 120 is a memory device that is outside of the video/image data processing system 300, the GPU 150 may receive data from the storage unit 120 through the operation of a memory controller (not shown) and a compatible system bus (not shown).

The video/image data processing system 300 of FIG. 7 may optionally further include a buffer circuit (not shown) for storing the first data that is the decoded data of the input stream STREAM_IN. In some embodiments, the buffer circuit may be included in the transcoding circuit 110.

In the embodiment of FIG. 7, the GPU 150 may operate to jump directly to a first block that includes target data among the plurality of blocks of the output stream STREAM_OUT, and to decode the first block.

FIG. 8 is a block diagram illustrating a video/image data processing system 400, in accordance with another embodiment of the inventive concepts.

Referring to FIG. 8, the video/image data processing system 400 may include a first storage unit 220, a transcoding circuit 210, a second storage unit 230 and a GPU 250.

The transcoding circuit 210 may operate to receive an input stream STREAM_IN having a first compression format with which a sequential access is possible from the first storage unit 220, decode the input stream STREAM_IN to generate first data, and encode the first data to generate an output stream STREAM_OUT having a second compression format with which a random access is possible. The second storage unit 230 receives and stores the output stream STREAM_OUT from the transcoding circuit 210.

The first storage unit 220 and the second storage unit 230 may comprise memory units, devices or systems that are within the video/image data processing system 400, or memory units, devices or systems that are external to the video/image data processing system 400. In a case where the first storage unit 220 and the second storage unit 230 comprise a memory device that is external to the video/image data processing system 400, the transcoding circuit 210 may receive/transmit data from/to the storage units 220 and 230 through the operation of a memory controller (not shown) and a compatible system bus (not shown).

The GPU 250 receives the output stream STREAM_OUT from the second storage unit 230, and performs graphic processing on the output stream STREAM_OUT. In a case where the second storage unit 230 is a memory device that is external to the video/image data processing system 400, the GPU 250 may receive data from the second storage unit 230 through the operation of a memory controller (not shown) and a compatible system bus (not shown).

The video/image data processing system 400 of FIG. 8 may further include a buffer circuit (not shown) for storing the first data that is the decoded data of the input stream STREAM_IN. In some embodiments, the buffer circuit may be included in the transcoding circuit 210.

In FIG. 8, the GPU 250 may operate to directly jump to a first block that includes target data among the plurality of blocks of the output stream STREAM_OUT, and decode the first block.

In FIGS. 7 and 8, in some embodiments, a data size of a decoded result of the output stream having the second compression format may be smaller than the data size of a decoded result of the input stream having the first compression format. In other embodiments, the data size of the decoded result of the output stream having the second compression format may be larger than the data size of a decoded result of the input stream having the first compression format. Further, in some embodiments, a buffer size needed to store a decoded result of the output stream having the second compression format may be smaller than the buffer size needed to store a decoded result of the input stream having the first compression format. In other embodiments, the buffer size needed to store a decoded result of the output stream having the second compression format may be greater than the buffer size needed to store a decoded result of the input stream having the first compression format.

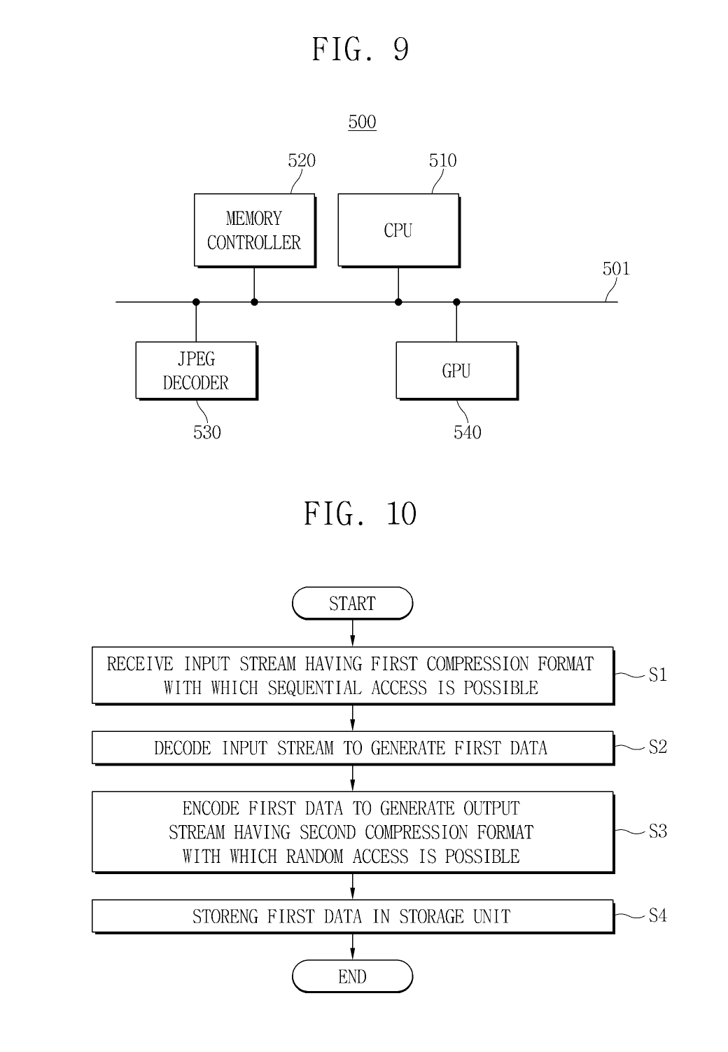

FIG. 9 is a block diagram illustrating a system-on-a-chip (SOC) 500 that includes one of the video/image data processing systems shown in FIGS. 1, 6, 7 and 8.

Referring to FIG. 9, the SOC 500 may include a central processing unit (CPU) 510, a memory controller 520, a JPEG decoder 530 and a GPU 540.

The CPU 510, the memory controller 520, the JPEG decoder 530 and the GPU 540 may receive/transmit data or control signals through a bus 501. The CPU 510 controls general operations of the memory controller 520, the JPEG decoder 530 and the GPU 540, and the memory controller 520 controls an operation of a memory (not shown) connected to the SOC 500.

In some embodiments, the JPEG decoder 530 may include one of the transcoding circuits 110 and 210 included in each of the video/image data processing systems shown in FIGS. 1, 6, 7 and 8. In such an embodiment, the JPEG decoder 530 receives an input stream STREAM_IN having a first compression format with which a sequential access is possible from the storage unit, decodes the input stream STREAM_IN to generate first data, encodes the first data to generate an output stream STREAM_OUT having a second compression format with which a random access is possible, and stores the output stream STREAM_OUT in the storage unit (not shown). In some embodiments, the storage unit may comprise a cache memory device that is within of the SOC 500, or may comprise a memory device that is external to the SOC 500. The JPEG decoder 530 may further include a buffer circuit (not shown) for storing data that is the decoded data of the input stream STREAM_IN.

In a case where the storage unit is a memory device that is external to the SOC 500, the JPEG decoder 530 may receive/transmit data from/to the storage unit through the operation of a memory controller (not shown) and a compatible system bus (not shown). The GPU 540 receives the output stream STREAM_OUT from the storage unit, and performs graphic processing on the output stream STREAM_OUT. When the storage unit is a memory device that is external to the SOC 500, the GPU 540 may receive data from the storage unit through the operation of a memory controller (not shown) and a compatible system bus (not shown).

FIG. 10 is a flow chart illustrating a method of processing video/image data, in accordance with an embodiment of the inventive concepts.

Referring to FIG. 10, in some embodiments, the method of processing video/image data may include the following operations:

(1) receiving an input stream having a plurality of data blocks and being formatted in a first compression format with which a sequential access is possible (S1);

(2) decoding the input stream to generate first data (S2);

(3) encoding the first data to generate an output stream having a plurality of data blocks and being formatted in a second compression format with which a random access is possible (S3); and

(4) storing the output stream in a storage unit (S4).

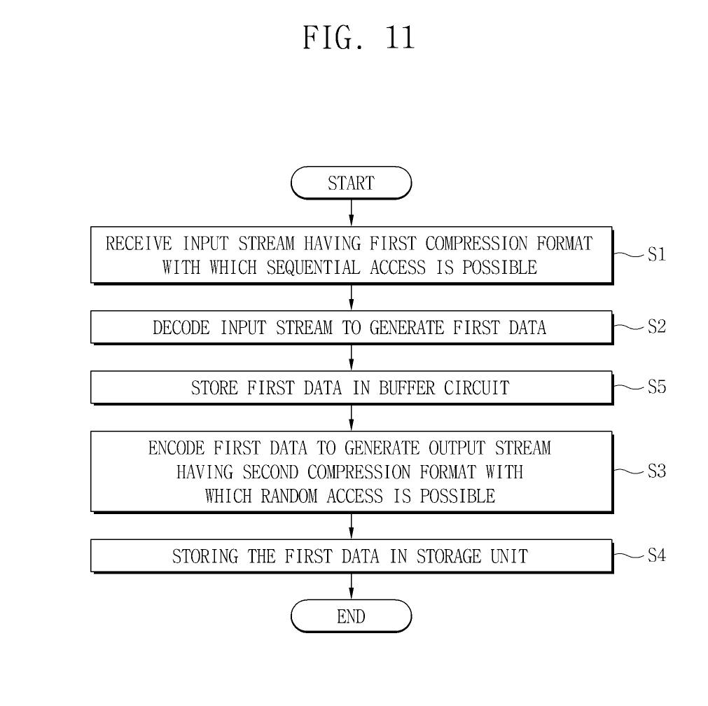

FIG. 11 is a flow chart illustrating a method of processing video/image data, in accordance with another embodiment of the inventive concept.

Referring to FIG. 11, in some embodiments, the method of processing video/image data may include the following operations:

(1) receiving an input stream having a plurality of data blocks and being formatted in a first compression format with which a sequential access is possible (S1);

(2) decoding the input stream to generate first data (S2);

(3) storing the first data in a buffer circuit (S5);

(4) encoding the first data to generate an output stream having a plurality of data blocks and being formatted in a second compression format with which a random access is possible (S3); and

(5) storing the output stream in a storage unit (S4).

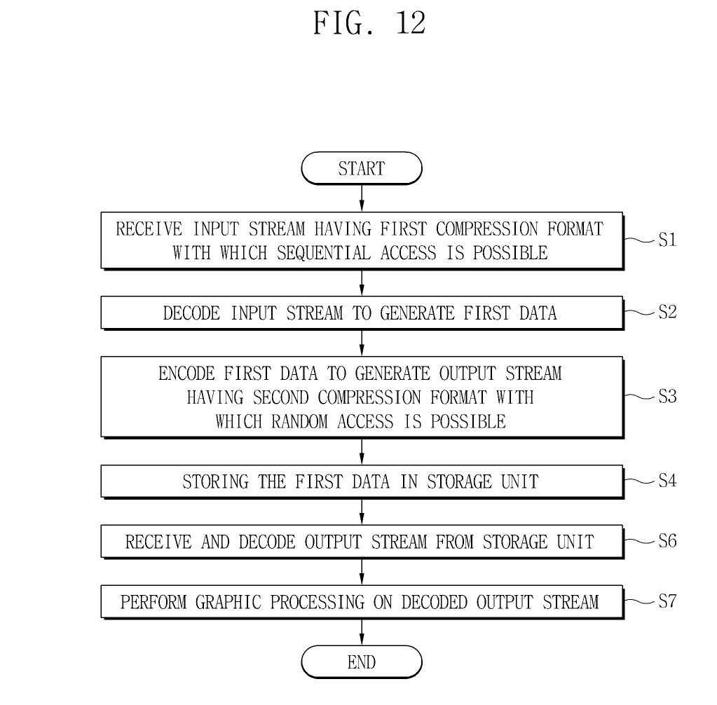

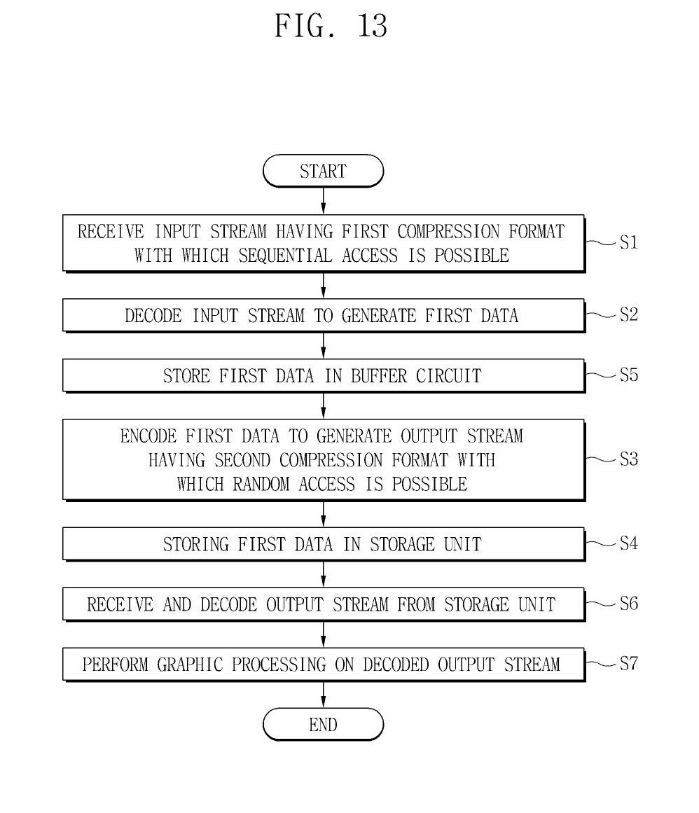

FIG. 12 is a flow chart illustrating a method of processing video/image data, in accordance with another embodiment of the inventive concept.

Referring to FIG. 12, in some embodiments, the method of processing video/image data may include the following operations:

(1) receiving an input stream having a plurality of data blocks and being formatted in a first compression format with which a sequential access is possible (S1);

(2) decoding the input stream to generate first data (S2);

(3) encoding the first data to generate an output stream having a plurality of data blocks and being formatted in a second compression format with which a random access is possible (S3);

(4) storing the output stream in a storage unit (S4);

(5) receiving and decoding the output stream from the storage unit (S6); and

(6) performing graphic processing on the decoded output stream (S7).

FIG. 13 is a flow chart illustrating a method of processing video/image data, in accordance with another embodiment of the inventive concept.

Referring to FIG. 13, in some embodiments, the method of processing video/image data may include the following operations:

(1) receiving an input stream having a plurality of data blocks and being formatted in a first compression format with which a sequential access is possible (S1);

(2) decoding the input stream to generate first data (S2);

(3) storing the first data to a buffer circuit (S5);

(4) encoding the first data to generate an output stream having a plurality of data blocks and being formatted in a second compression format with which a random access is possible (S3); and

(5) storing the output stream in a storage unit (S4).

(6) receiving and decoding the output stream from the storage unit (S6); and

(7) performing graphic processing on the decoded output stream (S7).

In the method of processing video/image data shown in FIGS. 12 and 13, the decoding of the output stream may include jumping directly to a first block that includes target data among a plurality of blocks of the output stream, and decoding the first block. Further, in the method of processing video/image data shown in FIGS. 12 and 13, the decoding of the output stream may include reading a header HEADER of the output stream, jumping directly to a first block indicated by the header HEADER among a plurality of blocks of the output stream, and decoding the first block. The target data may be included in the first block.

In the method of processing video/image data shown in FIGS. 10 through 13, in some embodiments, the first compression format and the second compression format may be block-based coded formats.

In the method of processing video/image data shown in FIGS. 10 through 13, in some embodiments, the second compression format may be used for a texture mapping in a three dimensional (3-D) graphic process.

In the method of processing video/image data shown in FIGS. 10 through 13, the first compression format may be an image/video compression format selected from at least one of JPEG, PNG GIF, MPEG H.264 and HEVC, and the second compression format may be a texture compression format selected from at least one of ASTC, S3TC, ETC, PVRTC, BC1, BC2, BC3, BC4, BC5, BC6 and BC7.

In general, video data compressed using a compression format such as H.264 or image data compressed using a compression format such as JPEG may not be arbitrarily accessed, but instead, blocks of the data stream may be sequentially accessed. Therefore, utilization of video/image data compressed using a conventional compression methods may be relatively inefficient. Methods of processing video/image data according to embodiments of the inventive concepts may provide for efficient performance of graphic processing in a graphic processing unit by converting the data from a compression format with which a sequential access is possible to a compression format with which a random access is possible.

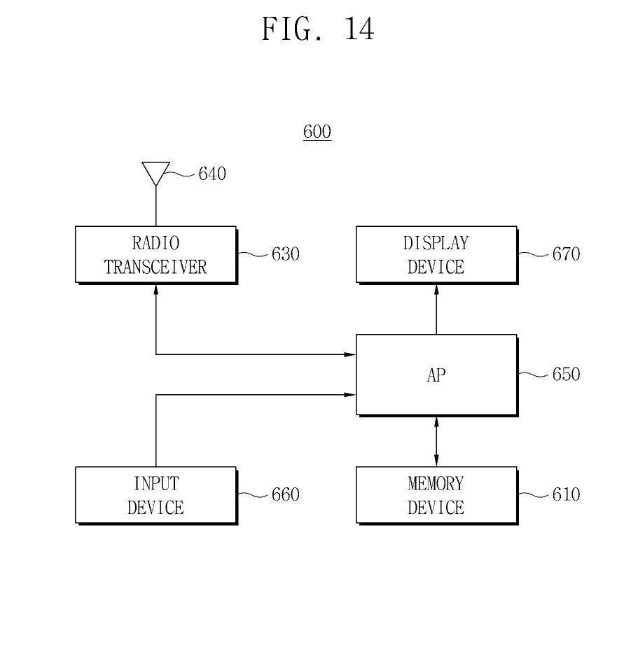

FIG. 14 is a block diagram illustrating an example of a computer system 600 that includes a video/image data processing system of the type shown and described in connection with FIG. 1, 6, 7 or 8.

Referring to FIG. 14, the computer system 600 includes a memory device 610, an application processor 650 including a memory controller that controls the memory device 610, a radio transceiver 630, an antenna 640, an input device 660, and a display device 670.

The radio transceiver 630 may transmit or receive a radio signal via the antenna 640. For example, the radio transceiver 630 may convert a radio signal received via the antenna 640 into a signal to be processed by the application processor 650.

Therefore, the application processor 650 may process the signal received from the radio transceiver 630, and transmit the processed signal to the display device 670. Further, the radio transceiver 630 may convert a signal received from the application processor 650 into a radio signal, and output the radio signal to an external device (not shown) via the antenna 640.

In some embodiments, the input device 660 may comprise a device capable of inputting a control signal for controlling an operation of the application processor 650 or data processed by the application processor 650, and embodied as a pointing device, such as a touch pad or computer mouse, a keypad, or a keyboard.

In accordance with embodiments of the inventive concepts, the application processor 650 may include one of the transcoding circuits 110 and 210 included in the video/image data processing systems shown in FIGS. 1, 6, 7 and 8.

FIG. 15 is a block diagram illustrating another example of a computer system 700 that includes one of the video/image data processing systems shown in FIGS. 1, 6, 7 and 8.

Referring to FIG. 15, the computer system 700 may be embodied as a personal computer (PC), a network server, a tablet PC, a net-book, an e-reader, a personal digital assistant (PDA), a portable multimedia player (PMP), an MP3 player, or an MP4 player.

The computer system 700 includes a memory device 710, an application processor 730 including a memory controller that controls the operation of data processing of the memory device 710, an input device 740 and a display device 750.

The application processor 730 may display data stored in the memory device 710 on the display device 750, based on data input via the input device 740. For example, the input device 740 may be embodied as a pointing device, such as a touch pad or computer mouse, a keypad, or a keyboard. The application processor 730 may control overall operations of the computer system 700, and may control an operation of the memory device 710.

In accordance with embodiments of the inventive concepts, the application processor 730 may include one of the transcoding circuits 110 and 210 included in the video/image data processing systems shown in FIGS. 1, 6, 7 and 8.

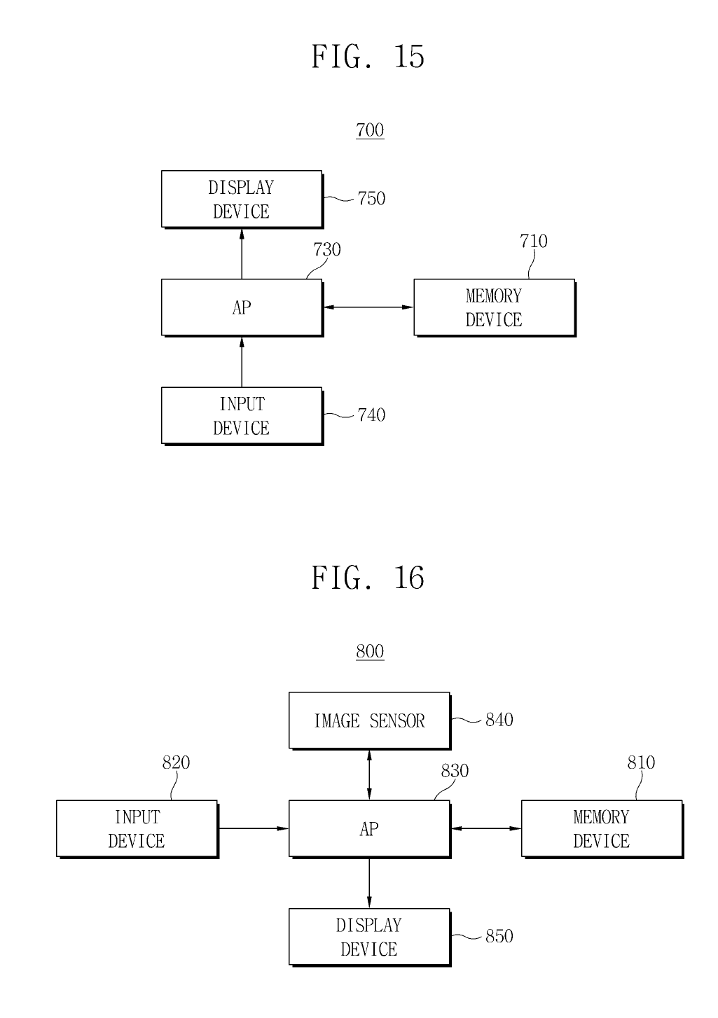

FIG. 16 is a block diagram illustrating still another example of a computer system 800 that includes one of the video/image data processing systems shown in FIGS. 1, 6, 7 and 8.

Referring to FIG. 16, the computer system 800 may be embodied as an image process device, such as a digital camera or mobile phone including a digital camera, a smart phone, or a tablet PC.

In some embodiments, the computer system 800 includes a memory device 810, an application processor 830 including a memory controller that controls a data processing operation, such as a write operation or read operation, of the memory device 810, an input device 820, an image sensor 840 and a display device 850.

The image sensor 840 of the computer system 800 converts an optical image into digital signals, and transmits the converted digital signals to the application processor 830. According to the control of the application processor 830, the converted digital signals may be displayed on the display device 850, or stored in the memory device 810.

For example, the input device 820 may be embodied as a pointing device, such as a touch pad or computer mouse, a keypad, or a keyboard. The application processor 830 may control overall operations of the computer system 800, and may control an operation of the memory device 810. Further, data stored in the memory device 810 may be displayed on the display device 850 according to the control of the application processor 830.

In accordance with embodiments of the inventive concepts, the application processor 830 may include one of the video/image data processing systems shown in FIGS. 1, 6, 7 and 8.

Embodiments of the inventive concepts may be applied to a graphic processing unit (GPU), and a system-on-a-chip (SOC) including the GPU.

The foregoing is illustrative of embodiments and is not to be construed as limiting thereof. Although a few embodiments have been described, those skilled in the art will readily appreciate that many modifications are possible in embodiments without materially departing from the novel teachings and advantages. Accordingly, all such modifications are intended to be included within the scope of the inventive concepts as defined in the claims.

1. A system-on-a-chip (SOC), comprising:
a JPEG decoder configured to receive an input stream of data blocks having a first compression format with which a sequential access is possible, to decode the input stream of data blocks to generate first data, and to encode the first data to generate an output stream of data blocks having a second compression format with which a random access is possible;
a graphic processing unit (GPU) configured to perform graphic processing on the output stream; and
a central processing unit (CPU) configured to control operations of the JPEG decoder and the GPU.

2. The SOC according to claim 1, wherein the GPU is configured to jump directly to a target block that includes target data among a plurality of blocks of the output stream of data blocks and to decode the target block.

3. The SOC according to claim 1, further comprising:
a buffer circuit configured to store the first data that is the decoded data of the input stream of data blocks.

4. A video/image data processing system including a transcoding circuit, the transcoding circuit comprising:
a first circuit configured to receive an input stream of data blocks having a first compression format with which a sequential access is possible, and to decode the input stream of data blocks to generate first data, and
a second circuit configured to encode the first data to generate an output stream of data blocks having a second compression format with which a random access is possible.

5. The system according to claim 4, wherein the first compression format and the second compression format are configured to be block-based coded formats.

6. The system according to claim 4, wherein the transcoding circuit comprises:
a decoder configured to decode the input stream of data blocks to generate the first data; and
an encoder configured to encode the first data to generate the output stream of data blocks having the second compression format with which random access is possible.

7. The system according to claim 4, wherein the transcoding circuit comprises:
a decoder configured to decode the input stream of data blocks to generate the first data;
a buffer circuit configured to store the first data that is the decoded data of the input stream of data blocks; and
an encoder configured to encode the first data to generate the output stream of data blocks having the second compression format with which random access is possible.

8. The system according to claim 4, wherein the input stream and the output stream include a plurality of data blocks respectively.

9. The system according to claim 8, wherein the transcoding circuit is configured to sequentially decode the input stream of data blocks from a beginning block to a block that includes target data among the plurality of blocks of the input stream.

10. The system according to claim 8, further comprising:
a GPU configured to receive the output stream of data blocks, and to decode the output stream of data blocks to perform graphic processing.

11. The system according to claim 10, wherein the GPU is configured to jump to a target block that includes target data among a plurality of blocks of the output stream and to decode the first block.

12. The system according to claim 10, wherein a data size of a decoded result of the output stream of data blocks having the second compression format is smaller than the data size of a decoded result of the input stream of data blocks having the first compression format.

13. The system according to claim 10, wherein a buffer size needed to store a decoded result of the output stream of data blocks having the second compression format is smaller than the buffer size needed to store a decoded result of the input stream of data blocks having the first compression format.

14. (canceled)

15. A method of processing video/image data for using the video/image data in a graphic process, the method comprising:
receiving an input stream having a plurality of data blocks and a first compression format with which a sequential access is possible;
decoding the input stream to generate first data, and
encoding the first data to generate an output stream of data blocks having a plurality of blocks and a second compression format with which a random access is possible.

16. The method according to claim 15, further comprising:
storing the first data in a buffer circuit.

17. The method according to claim 15, wherein the first compression format and the second compression format are block-based coded formats.

18. The method according to claim 15, wherein the generating of the first data comprises:
sequentially decoding the plurality of blocks of the input stream from a beginning block to a block having target data.

19. The method according to claim 15, further comprising:
storing the output stream of data blocks in a storage unit.

20. The method according to claim 19, further comprising:
receiving the output stream from the storage unit; and
decoding the output stream of data blocks to use in the graphic process.

21. The method according to claim 20, wherein the decoding of the output stream is configured to jump to a target block that includes target data among a plurality of blocks of the output stream of data blocks, and to decode the target block.

22-30. (canceled)
